(19) United States
(12) Patent Application Publication
(10) Pub. No.: US 2014/0111841 A1
(43) Pub. Date: Apr. 24, 2014

(54) Offset Axis Laser Scanner Apparatus

(71) Applicant: ISC8 Inc., Costa Mesa, CA (US)

(72) Inventor: Itzhak Sapir, Irvine, CA (US)

(21) Appl. No.: 14/057,065

(22) Filed: Oct. 18, 2013

Related U.S. Application Data
(60) Provisional application No. 61/715,917, filed on Oct. 19, 2012.

(51) Int. Cl. G02B 26/08

(52) U.S. Cl. CPC G02B 26/0816
USPC 359/226.1

(57) ABSTRACT

A laser scanner apparatus with an electromagnetic radiation source configured to transmit a laser beam having a beam path. A cylindrical element is provided with an electromagnetically reflective surface. The laser source is configured so the beam is incident on the reflective surface at a predetermined incident angle. The cylindrical element is configured to be driven to rotate at a predetermined rotation rate about an offset longitudinal axis whereby the beam path of the incident beam is varied so as to scan a scene of interest.

### CROSS-REFERENCE TO RELATED APPLICATIONS

This application claims the benefit of U.S. Provisional Patent Application No. 61/715,917, filed on Oct. 19, 2012, entitled “Offset Axis Laser Scanner Apparatus” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of laser scanning systems. More specifically, the invention relates to a low-cost laser scanner apparatus that uses a reflective cylindrical element rotating about an offset longitudinal axis to scan an incident laser beam across a scene of interest in cooperation with system optics for use in, for instance, a light detection and ranging detector or LIDAR system.

2. Description of the Related Art

Prior art laser scanners having laser transmitters angularly disposed to a reflective scanner surface typically use a rotating assembly of flat mirrors or an oscillating mirror that covers the desired scan angle. The size of the mirrors in the prior art must be provided such that the entire beam diameter is reflected from the reflective surface at a relatively extreme angle. This undesirably results in significant mirror size increase as the scan angle increases.

The above prior art approaches have additional limitations, i.e., the rotating mirror assembly of the prior art has “dead” periods or zones that occur when one scanning mirror moves out of the beam line and another one comes in.

The oscillating mirror scanning assembly of the prior art undesirably has non-continuous scanning movement with relatively high acceleration-deceleration periods that detrimentally increase power consumption, complicate control and decrease system scan performance.

The prior art limitations described above are inherent to the mechanical concepts behind them. To date, solutions to these deficiencies in the prior art have involved design optimization for each approach but with no material conceptual breakthrough.

The invention herein takes advantage of continuous rotational motion with an optical approach that decouples scan angle from size. No such solution is known to be used in the prior art.

### BRIEF SUMMARY OF THE INVENTION

In a first aspect of the invention, a laser scanner apparatus is disclosed comprising an electromagnetic radiation source configured to transmit a beam having a beam path, which source may comprise a laser source. A cylindrical element is provided comprising an electromagnetically reflective surface. The source is configured whereby the beam is incident on the reflective surface at a predetermined incident angle. The cylindrical element is configured to be driven to rotate at a predetermined rotation rate about an offset longitudinal axis whereby the beam path of the incident beam is varied so as to scan a scene of interest.

In a second aspect of the invention, the apparatus may further comprise a transmission optical element disposed in the beam path that is configured to optically modify a transmitted beam before it is transmitted to a scene of interest.

In a third aspect of the invention, the transmission optical element may comprise a collimating lens element.

In a fourth aspect of the invention, the apparatus may further comprise a receiver optical element configured to optically modify the beam after the beam is reflected from a scene of interest.

In a sixth aspect of the invention, a method for scanning a scene of interest with an electromagnetic beam is disclosed comprising the steps of rotating a cylinder comprising an electromagnetically reflective surface about an offset longitudinal axis of rotation and imaging an electromagnetic beam on the reflective surface whereby an angle of incidence of the beam on the reflective surface is varied dependent on a rotation position of the cylinder whereby the beam is scanned across the scene of interest.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims arc expressly formulated under 35 USC 112, are to be accorded full statutory equivalents under 35 USC 112.

### BRIEF DESCRIPTION OF THE SEVERAL VIEWS OF THE DRAWINGS

FIG. 1 shows a preferred embodiment of the laser scanner apparatus of the invention.

FIGS. 2A-2L shows a set of side views of a preferred embodiment of the laser scanner apparatus of the invention in a set of sequential positions during a single operational cylinder rotation.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

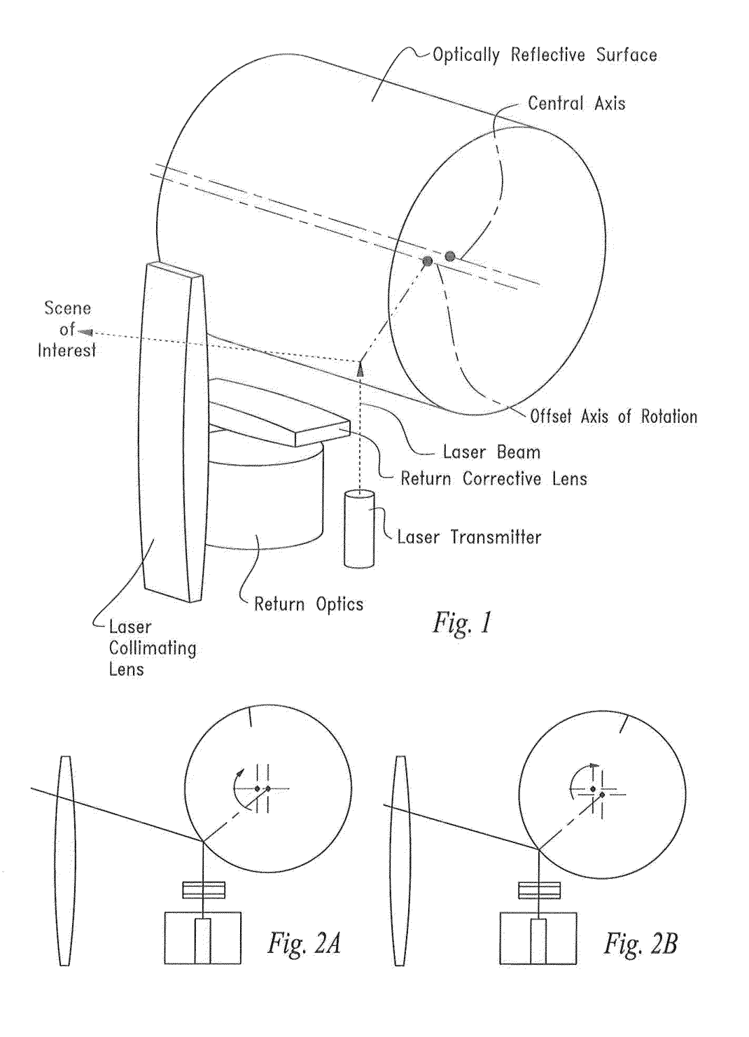

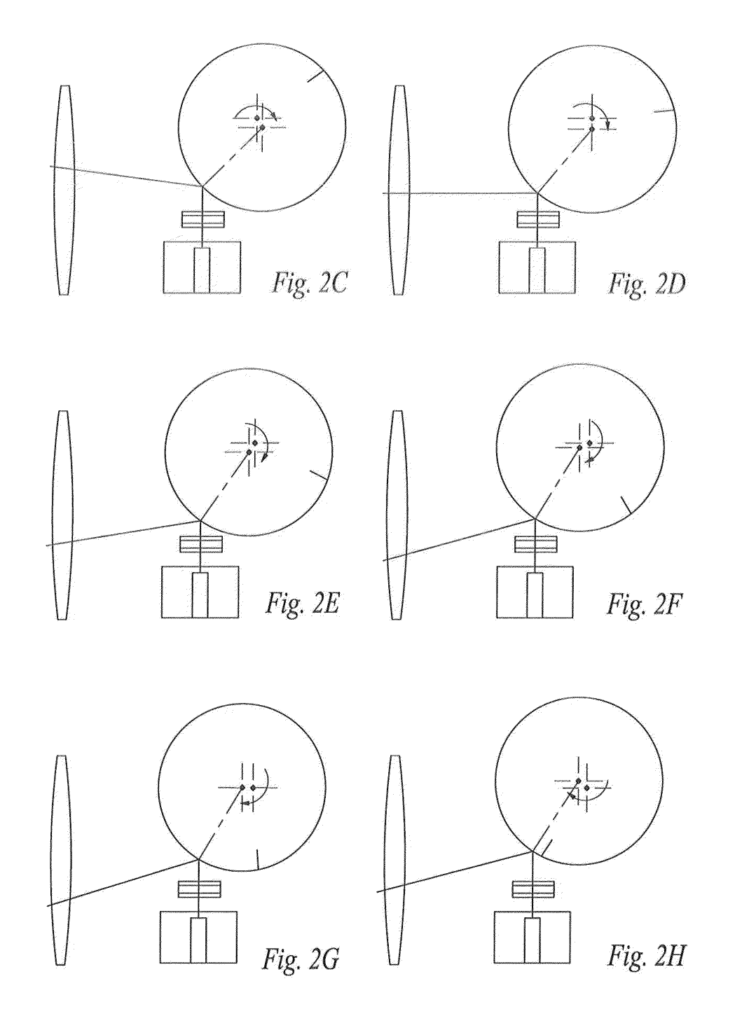

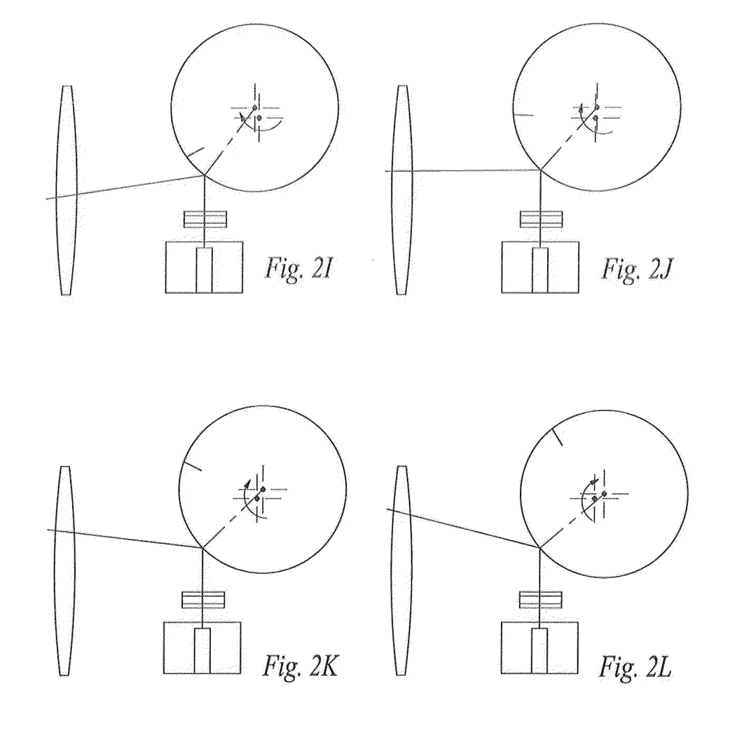

Turning now to FIGS. 1 and 2A-2L, wherein like references define like elements among the several views. Applicant discloses an offset axis laser scanner apparatus 1 for use in, for instance, a LIDAR imaging system.

The apparatus is suitable for, but not limited to applications requiring scanning a scene of interest with a laser beam and detecting the time-of-flight or phase change of the return echo of the transmitted beam in order to create a set of three-dimensional voxel image data frames that are representative of the scene.

Laser scanner apparatus 1 of the invention is comprised of a driven rotating cylinder element 5 having a substantially circular cross-section and having an optically reflective or mirrored exterior surface 10 as depicted in FIG. 1.

The longitudinal central axis of rotation 15 of cylinder 5 is shifted or offset a predetermined distance to define a longitudinal offset axis of rotation 20, about which cylinder 5 is configured to be driven. In other words, cylinder 5 is configured to be driven to rotate about offset axis 20 so as to effect an eccentric rotation or rotational wobble during operation.

An electromagnetic radiation source 25, such as a laser source, is configured such that beam 30 is angularly incident upon reflective surface 10 at a position that is offset from the central axis of rotation 15 of the cylinder by a predetermined offset amount so as to define a predetermined scan area of the beam.

The eccentric rotation of cylinder 5 effected by its rotation about offset axis 20 creates a continuously varying angle of incidence between beam 30 and cylinder 5 that, in turn, generates an angular and continuously varying scan angle of transmitted beam 30′ as further discussed in the operational sequence of the invention depicted in FIGS. 2A-2L.

Because of the curvature of the surface of cylinder 5, reflected beam 30′ is angularly reflected therefrom, which angle is dependent on the angle of incidence of beam 30 thereon, such that the beam incidence angle is continuously and smoothly varying as cylinder 5 is rotating.

A suitable transmission optical element 35, such as a collimating lens element that covers the desired scan angle, is preferably disposed between the scene of interest and cylinder 5 to focus transmitted beam 30′ as desired.

Laser scanner apparatus 1 as described above can be beneficially implemented as a laser scanner in combination with any number of different types and combinations of return (i.e., collection) optics 40 and sensors (not shown) or both.

In a LIDAR scanning application, the illustrated embodiment of FIG. 1 may be used not only for generating a scanning laser beam for illumination of a scene of interest in a LIDAR system, but may also be implemented for scanning the received or reflected beam from the scene of interest onto a focal plane array of pixel or detector elements in a synchronous manner and such an embodiment is expressly contemplated as within the scope of the invention.

The invention provides a laser scanner apparatus with continuous rotational scanning motion, no dead scan periods and a scan angle that can be increased or altered merely by changing the relative position of its components and the eccentricity or rotation axis of cylinder 5.

FIG. 1 illustrates a preferred embodiment comprising receiver optical elements 40 which may be configured for use with a detector element, focal plane array or line sensor in a LIDAR system.

In the illustrated embodiment of FIG. 1, the returned, received or echo beam is incident upon reflective surface 10 and is reflected in the direction of the transmitted beam. Suitable transmission or receiving optics or both may be used to correct optical distortion created by cylinder 5 and additional optical elements may be employed to focus, modify or alter the received beam on a focal plane array or line sensor.

Desirably, compact scanner system size is maintained using the invention's small cylinder element having high optical power that is easily optically compensated by a collimating lens.

Turning now to FIGS. 2A-2H, apparatus 1 of the invention is shown in operation in a set of about 30-degree sequential rotational positions as cylinder 5 is being driven to rotate about offset axis 20.

As depicted in FIG. 2A, cylinder 5 is shown at an initial position and is being rotated clockwise about offset axis 20 and having beam 30 incident on reflective surface 10 thereon.

Due to the incident angle of beam 30 on cylinder 5 at the rotational position illustrated in FIG. 2A, transmitted beam 30′ is thus angularly reflected by surface 10 at, in the illustration of FIG. 2A, an angle relative to beam 30.

As can be seen in the remaining sequence of FIGS. 2B-2L, as cylinder 5 continues to rotate about offset axis 20 over the illustrated 30-degree positions in a single cylinder rotation, the angle between beam 30 and transmitted beam 30′ is continuously and smoothly varied as the incident angle of beam 30 on reflective surface 10 varies over the rotation, thus continuously and smoothly scanning transmitted beam 30 across a scene of interest.

In this manner, when the echo of the transmitted beam from a surface in a scanned scene of interest is captured and processed using appropriate optics and electronics, a 3-D LIDAR voxel image frame set of the scene may be created.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A laser scanner apparatus comprising:
an electromagnetic radiation source configured to transmit a beam having a beam path,
a cylindrical element comprising an electromagnetically reflective surface,
the source configured whereby the beam is incident on the reflective surface at a predetermined incident angle, and,
the cylindrical element configured to rotate at a predetermined rotation rate about an offset longitudinal axis whereby the beam path is varied.

2. The apparatus of claim 1 further comprising a transmission optical element disposed in the beam path that is configured to optically modify a transmitted beam before it is transmitted to a scene of interest.

3. The apparatus of claim 2 wherein the transmission optical element is a collimating lens element.

4. The apparatus of claim 1 further comprising a receiver optical element configured to optically modify the beam after the beam is reflected from the scene of interest.

5. A method for scanning a scene of interest with an electromagnetic beam comprising the steps of:
rotating a cylinder comprising an electromagnetically reflective surface about an offset longitudinal axis of rotation, and,
imaging an electromagnetic beam on the reflective surface whereby an angle of incidence of the beam on the reflective surface is varied dependent on a rotation position of the cylinder whereby the beam is scanned across the scene of interest.
